(19) United States
(12) Patent Application Publication
(10) Pub. No.: US 2014/0122437 A1
(43) Pub. Date: May 1, 2014

(54) DYNAMICALLY PROVISIONED STORAGE SERVER OPERATING ON A DATA COMMUNICATIONS NETWORK

(71) Applicant: Charles Bosson, Ojai, CA (US)

(72) Inventor: Charles Bosson, Ojai, CA (US)

(73) Assignee: KASEYA INTERNATIONAL LIMITED, St. Helier (JE)

(21) Appl. No.: 13/665,328

(22) Filed: Oct. 31, 2012

(51) Int. Cl. G06F 17/30

(52) U.S. Cl. 707/652; 707/E17.005

(57) ABSTRACT

Disclosed are an apparatus and method of performing a data backup operation across a network. The method according to one example may include receiving a request to perform a data backup operation at a server, and identifying at least one agent application operating on a remote network device. The method may also include transmitting a setup file to the remote network device to be installed via the agent application and performing the data backup operation responsive to installing the at least one setup file on the remote network device.

### TECHNICAL FIELD

This disclosure relates to a method and apparatus of accessing and dynamically provisioning a storage server, and more specifically, configuring and/or provisioning the storage server responsive to a client request for data backup or similar storage server operations.

### BACKGROUND

Clients and client machines operating on a local area network (LAN), wide area network (WAN) and/or enterprise network are often seeking access to a centralized data backup server or cloud server device. Like many server functions, operations and services, data backup operations are generally not performed continuously on the communication network. In fact, server backup operations may be referred to as intermittently conducted server operations that are performed on an ‘as needed’ basis.

### SUMMARY

One embodiment of the present application may include a method of performing a data backup operation across a network, the method may include receiving a request to perform a data backup operation at a server, identifying at least one agent application operating on a remote network device, transmitting at least one setup file to the remote network device to be installed via the agent application, and performing the data backup operation responsive to installing the at least one setup file on the remote network device.

Another example embodiment may provide an apparatus configured to perform a data backup operation across a network. The apparatus may include a receiver configured to receive a request to perform a data backup operation at a server. The apparatus may also include a processor configured to identify at least one agent application operating on a remote network device, and a transmitter configured to transmit at least one setup file to the remote network device to be installed via the agent application. The processor is further configured to perform the data backup operation responsive to the at least one setup file being installed on the remote network device.

### BRIEF DESCRIPTION OF THE DRAWINGS

FIG. 1 illustrates an example application communication session, according to an example method of operation of the present application.

FIG. 2 illustrates an example logic diagram of a dynamic storage server provisioning procedure according to example embodiments.

FIG. 3 illustrates a dynamic storage server system according to example embodiments.

FIG. 4 illustrates a flow diagram of an example method according to an example embodiment of the present application.

FIG. 5 illustrates an example network entity device configured to store instructions, software, and corresponding hardware for executing the same, according to example embodiments of the present application.

### DETAILED DESCRIPTION

It will be readily understood that the components of the present application, as generally described and illustrated in the figures herein, may be arranged and designed in a wide variety of different configurations. Thus, the following detailed description of the embodiments of a method, apparatus, and system, as represented in the attached figures, is not intended to limit the scope of the application as claimed, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present application, the application may be applied to many types of network data, such as, packet, frame, datagram, etc. For purposes of this application, the term “message” also includes packet, frame, datagram, and any equivalents thereof. Furthermore, while certain types of messages and signaling are depicted in exemplary embodiments of the application, the application is not limited to a certain type of message, and the application is not limited to a certain type of signaling.

According to example embodiments of the present application, a server may be a local or a remote computer, a server and/or a related computing device. A client may be any computer, machine or related computing device that is connected directly to the server or over a remote network connection to the server. The client or client device may be a computer, laptop, mobile, wireless or cellular phone, a PDA, a tablet, a client, a server or any device that contains a processor and/or memory, whether that processor or memory performs a function related to an embodiment of the application.

A server agent may be a server application that is a web-based application that permits the server to manage and/or communicate with one or more client machines. A secure network channel may be setup and established between the server machine and the client machine via the agent application. The secure network channel may provide connections over which data packets may be exchanged. The network channel may pass through a wide area network (WAN) (e.g. the Internet) or through a private local area network (LAN). A client agent application may be an application that includes a process running on the client machine. The client agent application accepts connections from the server agent application and assists with setting up a channel and transmitting and receiving commands and data.

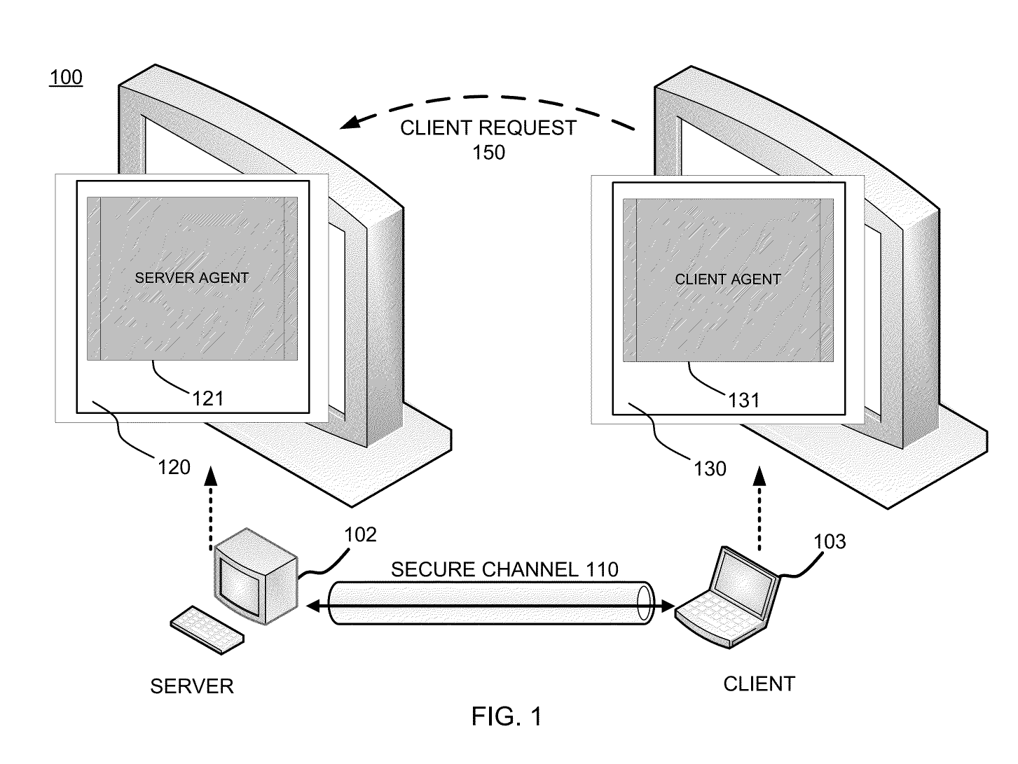

One example method of communicating between the server machine 102 and the client machine 103 is illustrated in detail below with reference to FIG. 1. Referring to FIG. 1, the communication network 100 may include at least one server and one client device. The server may include a server agent application 121 of the server device user interface 120, which may include an agent plug-in used to execute and run in a web browser of the user interface 120 on the server 102. The web browser may establish a connection through a proprietary secure channel 110 to an client agent application 131 running on the application desktop 130 of the client machine 103.

In operation, the server 102 browses for a particular client machine 103 viewable from the server agent application 121. The server plug-in initiates a connection via a secure channel to an client agent application 131 of the remote client machine 103. The client agent application 131 operating on the client machine 103 accepts and acknowledges the connection establishment by transferring an acceptance message back to the server agent application 121. After session establishment, the server 102 may receive a notification or web browser-based indicator that commands may now be received by the client machine 103. The server 102 may then launch a process to be executed on the client machine 103.

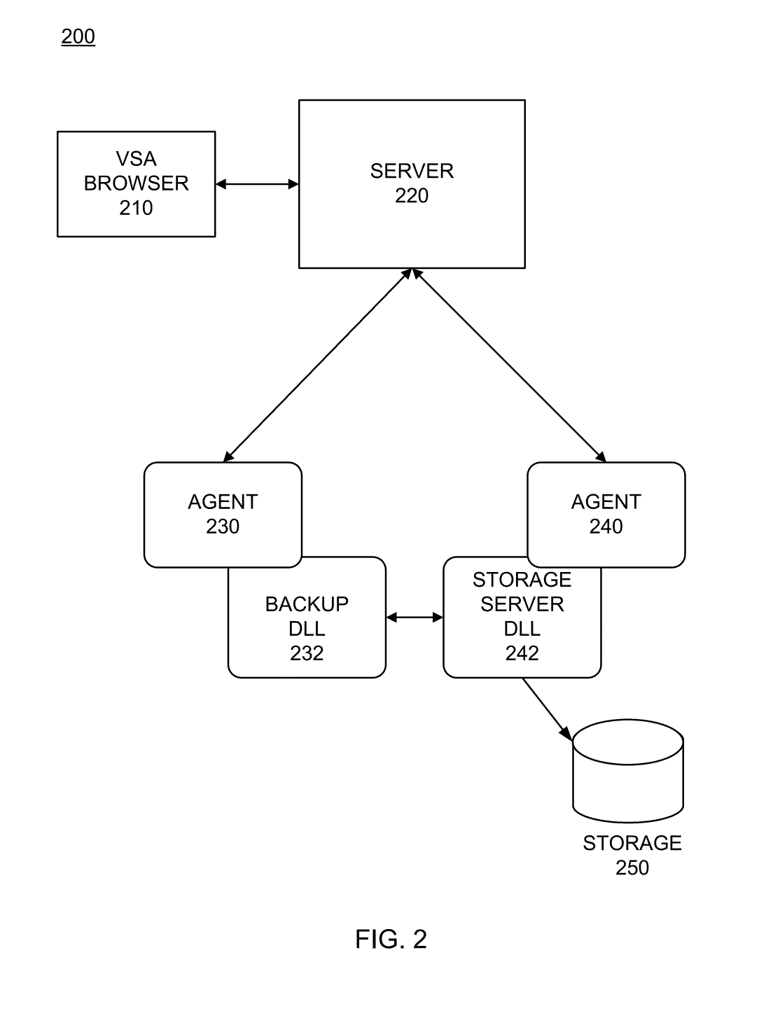

FIG. 2 illustrates an example logic diagram of a dynamic storage server provisioning operation according to example embodiments. Referring to FIG. 2, the communication network logic diagram 200 may include a virtual systems server (VSA) operated as a browser application or interface 210 that is part of the server device 220. The operations conducted by the server 220 may include connecting with an agent application 230 and/or 240 on remote network device(s) (e.g., servers, client devices, peripheral devices, etc.). The server 220 may have its own agent application installed that creates a secure communication channel with other agent application on the client devices. The agents 230 and/or 240 may be part of the same network device or different network devices operating on the same data communications network.

Other network configurations may include a wide area network (WAN), such as the Internet, that is used to connect one or more communications devices. The VSA browser 210 may be a network portal, browser or other communication medium or device that is used to establish a connection from the server machine 102 to the remotely client machine 103. The virtual system server (VSA) 340 may be an interface-based website that is accessible via a user terminal computer or other user interface device. The VSA browser interface 210 is a functional interface that may be used to perform operations and/or functions and control program execution.

According to one example embodiment with reference to FIG. 2, the virtual systems server (VSA) 210 may be operating as portal or third party device that assigns work management policies to remote agent processes connected to the VSA 210 over a wide area network (WAN). For example, the VSA 210 may be setup to update and execute actions on remote agent applications operating on various different network machines. Policies may be used to dictate when a backup operation begins and ends, and certain triggers may be dynamically provided to any of a plurality of agents 230/240 installed on the client machines 103. Alternatively, the agent applications may be operating as part of the same storage server or management server 220.

According to one example embodiment, a storage server or virtual storage server may be setup, provisioned, operated and executed on-the-fly responsive to a received command or other trigger operation. The dynamically provisioned storage server may be setup, provisioned and configured to begin storing data, backing-up data, retrieving data and processing requests to perform one or more of the above-noted operations. The dynamically provisioned storage server may be a virtual server, one server device, multiple server devices, multiple computing devices, etc. The storage server may not exist within a particular network operated by clients requesting such storage functions. The storage server may be a provisional server that is accessible from a third party service network (i.e., cloud computing services). The storage server may be identified, setup and used to perform a data backup operation responsive to receiving and processing the client request.

The backup server function may not operate except when a client request is received. The authentication of the client seeking access to the storage server may be performed at the time of performing a backup operation. For example, a storage location may be unknown prior to a backup or storage server related operation. As a result of receiving the data backup operation request, the server may be identified among a list of available devices that can provide such a service either within the same network as the client computing device that sent the request or via a third party service network. The request for data backup operations may be a message that invokes a device selection, an estimated data backup size, an authentication operation to authenticate the client requesting device, and/or a target storage location being defined. The message may include any or more of the above-noted information parameters.

In operation, during a storage device setup operation, there may not be any port listening or any dedicated ports assigned to receive data backup requests. The VSA browser 210 may be used to setup or schedule a backup operation by notifying a server 220 to launch a set of script operations. For example, the VSA browser 210 may receive the client request for a backup and notify a server 220 to launch one or more script files and/or dynamic linked library files (DLLs) to the agents of corresponding devices configured to provide backup functions.

One agent 230 may be operating as a backup device that receives a backup DLL file from the server 232 responsive to the received request for backup services. The backup DLL 232 may be received and executed to launch a backup operator. Another agent 240 may be part of a server device that receives a storage server DLL 242 from the server 220 responsive to the backup request being received. Once the DLLs are installed, the backup DLL 232 may authenticate the storage server DLL 242 and identify the client request and authenticate the requesting client device. Then, the backup operation may be signaled to begin via the storage server DLL 242. Both the DLLs 232 and 242 may exchange a session key for authentication. As a result, the storage server DLL 242 may transmit a request to begin to the remote storage server 250, database or other device located at a remote or internal location.

According to example, embodiments, there are a number of ways a backup operation may be initiated. For example, a one-time backup operation may be triggered by the customer via a web user interface. The backup(s) may be scheduled to begin at regular intervals. These backups are then triggered by a separate service operating on the server. Backups can also be triggered by file changes detected on the agent (e.g., continuous data protection measures). In this example, the agent is backed up by having a process for detecting changes to certain files, and this corresponding process transmits requests to the server to initiate a backup on the agent application.

The client device and the agent host may be the same application/device. The backup DLL and the optional continuous data protection DLL may also be part of the same client device. The dedicated server is not normally used for storage but may delegate the responsibility of setting up the storage server. This server may operate as an agent in conjunction with the server. The server downloads the necessary objects to the agent machine, and the agent runs them as needed. In general, the agent is separate from the server. However, the agent and the server may be the same machine. The storage server can be either in the cloud but could be any provider or even on the customer's local machines and network.

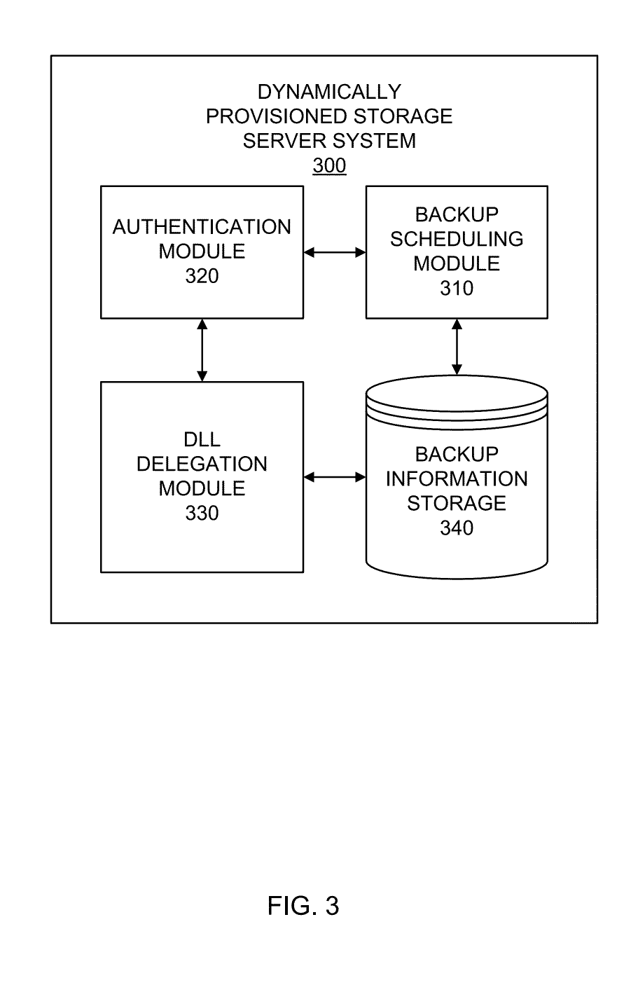

FIG. 3 illustrates an example dynamic provisioned storage server system 300 according to example embodiments of the present application. Referring to FIG. 3, the system 300 may be configured to perform a data backup operation across a network. The system 300 may be a stand alone device, a server, a client computing device, a set of more than one devices, or devices communicating across a network. The backup scheduling module 310 may receive a request to perform a data backup operation from a client device operating on the network. The backup scheduling module 310 may then identify at least one agent application operating on a remote network device. The system may include a processor(s) and transmitter/receiver pair configured to transmit at least one setup file to the remote network device to be installed via the agent application. The file may be one or more DLLs identified, transferred and delegated via a DLL delegation module 330. The DLLs may be files that are needed to enact the storage server authentication, setup and storage operations. Once the DLLs have been transferred and installed via the appropriate agent applications, the authentication module 320 may identify that the correct DLLs are installed and confirm that they are properly authenticated prior to performing any data backup operations. The system 300 may then perform the data backup operation responsive to installing the at least one setup file or DLL files on the remote network device(s).

The request for data backup may be received from a client device operating on the network. The client may be setup to communicate with the server via a client/server network system model. The request for data backup may include a backup schedule that includes at least one time to perform the data backup operation. The system 300 may identify at least one agent application operating on a remote network device by identifying a first agent application and a second agent application. Also, the setup file may include one or more DLLs including a backup dynamic linked library (DLL) sent to the first agent and a storage server DLL sent to the second agent application.

An authentication operation may be performed between the first agent application and the second agent application, and assuming the authentication was successful, the data backup operation may be created as a task to be assigned to a storage server. The data backup task may be sent to a remote database which is configured to receive and store the backup data. The remote database may be a cloud server or database that is initiated to store backup data via a data feed provided in response to the data backup task being created. The remote database or information storage 340 is configured to perform backup data operations only responsive to the request to perform the data backup operation being received. Also, the authentication operation may be performed responsive to the data backup operation being performed via the authentication module 320.

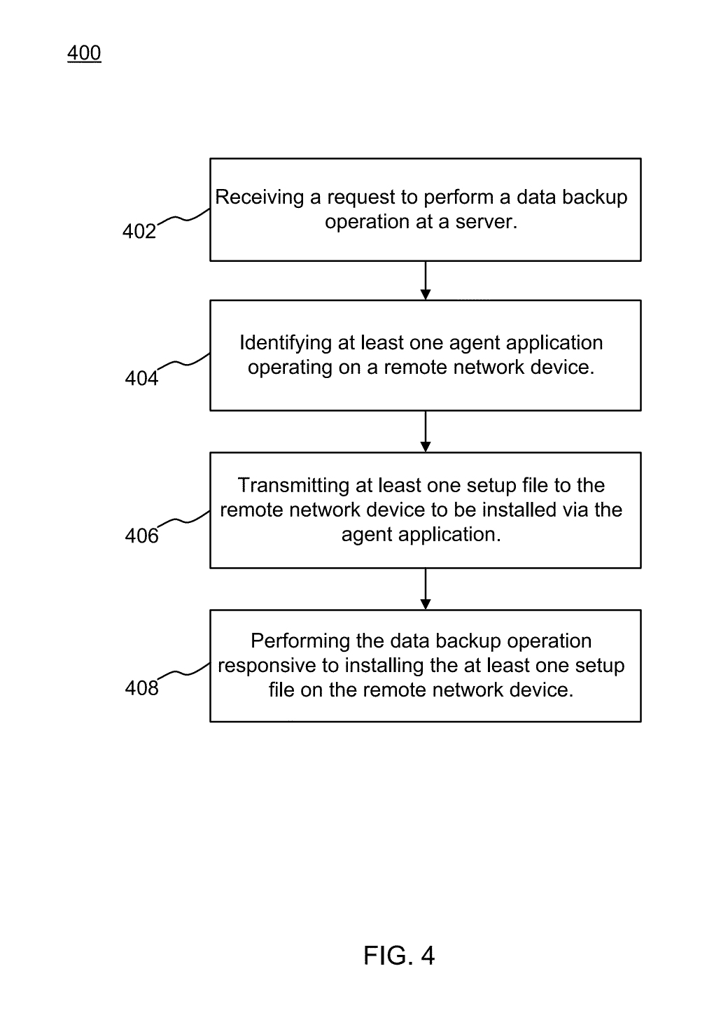

FIG. 4 illustrates an example flow diagram of an example method of operation according to example embodiments. Referring to FIG. 4, the flow diagram 400 may include a method of performing a data backup operation across a network. The method may include receiving a request to perform a data backup operation at a server, operation 402. The method may also include identifying at least one agent application operating on a remote network device, operation 404. The method may also include transmitting at least one setup file to the remote network device to be installed via the agent application, at operation 406 and performing the data backup operation responsive to installing the at least one setup file on the remote network device, at operation 408.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

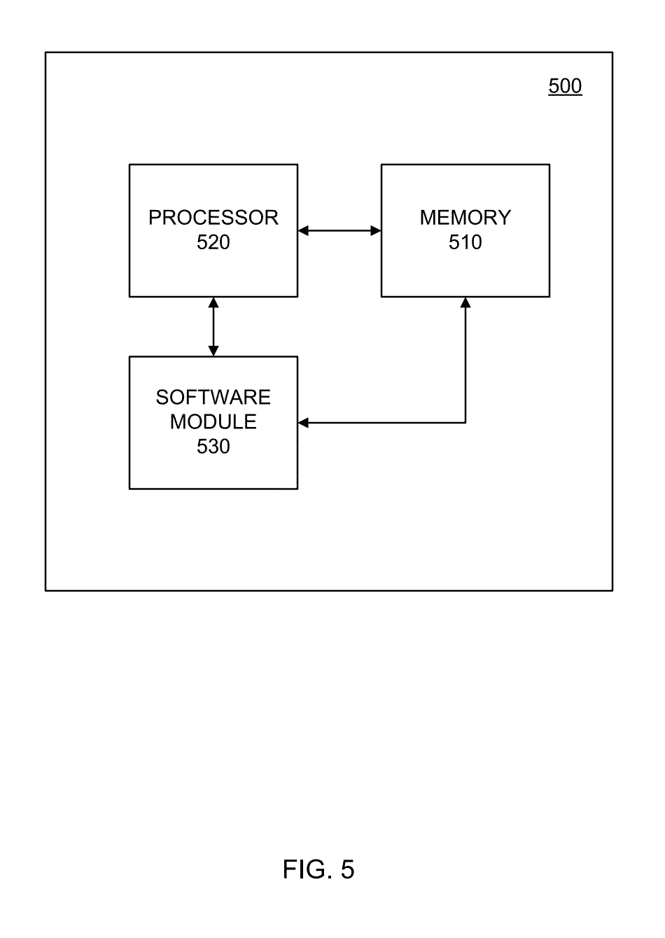

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example FIG. 5 illustrates an example network element 500, which may represent any of the above-described network components.

As illustrated in FIG. 5, a memory 510 and a processor 520 may be discrete components of the network entity 500 that are used to execute an application or set of operations. The application may be coded in software in a computer language understood by the processor 520, and stored in a computer readable medium, such as, the memory 510. The computer readable medium may be a non-transitory computer readable medium that includes tangible hardware components in addition to software stored in memory. Furthermore, a software module 530 may be another discrete entity that is part of the network entity 500, and which contains software instructions that may be executed by the processor 520. In addition to the above noted components of the network entity 500, the network entity 500 may also have a transmitter and receiver pair configured to receive and transmit communication signals (not shown).

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method of performing a data backup operation across a network, the method comprising:
receiving a request to perform a data backup operation at a server;
identifying at least one agent application operating on a remote network device;
transmitting at least one setup file to the remote network device to be installed via the agent application; and
performing the data backup operation responsive to installing the at least one setup file on the remote network device.

2. The method of claim 1, wherein the request is received from a client device operating on the network.

3. The method of claim 1, wherein the request comprises a backup schedule comprising at least one time to perform the data backup operation.

4. The method of claim 1, wherein identifying at least one agent application operating on a remote network device comprises identifying a first agent application and a second agent application, and wherein transmitting the at least one setup file to the remote network device comprises transmitting a backup dynamic linked library (DLL) to the first agent and transmitting a storage server DLL to the second agent application.

5. The method of claim 4, further comprising:
performing an authentication operation between the first agent application and the second agent application; and
responsive to the authentication operation, creating at least one data backup task; and
transmitting the data backup task to a remote database which is configured to receive and store the backup data.

6. The method of claim 1, wherein the remote database is configured to perform backup data operations only responsive to the request to perform the data backup operation being received.

7. The method of claim 1, wherein the authentication is performed responsive to the data backup operation being performed.

8. An apparatus configured to perform a data backup operation across a network, the apparatus comprising:
a receiver configured to receive a request to perform a data backup operation at a server;
a processor configured to identify at least one agent application operating on a remote network device; and
a transmitter configured to transmit at least one setup file to the remote network device to be installed via the agent application, and
wherein the processor is further configured to perform the data backup operation responsive to the at least one setup file being installed on the remote network device.

9. The apparatus of claim 8, wherein the request is received from a client device operating on the network.

10. The apparatus of claim 8, wherein the request comprises a backup schedule comprising at least one time to perform the data backup operation.

11. The apparatus of claim 8, wherein the identification of at least one agent application operating on a remote network device comprises the identification of a first agent application and a second agent application, and wherein the at least one setup file being transmitted to the remote network device comprises a backup dynamic linked library (DLL) being transmitted to the first agent and a storage server DLL being transmitted to the second agent application.

12. The apparatus of claim 11, wherein the processor is further configured to perform an authentication operation between the first agent application and the second agent application, and responsive to the authentication operation, to create at least one data backup task, and wherein the transmitter is further configured to transmit the data backup task to a remote database which is configured to receive and store the backup data.

13. The apparatus of claim 8, wherein the remote database is configured to perform backup data operations only responsive to the request to perform the data backup operation being received.

14. The apparatus of claim 8, wherein the authentication is performed responsive to the data backup operation being performed.

15. A non-transitory computer readable storage medium configured to store instructions that when executed cause a processor to perform a data backup operation across a network, the method comprising:
receiving a request to perform a data backup operation at a server;
identifying at least one agent application operating on a remote network device;
transmitting at least one setup file to the remote network device to be installed via the agent application; and
performing the data backup operation responsive to installing the at least one setup file on the remote network device.

16. The non-transitory computer readable storage medium of claim 15, wherein the request is received from a client device operating on the network.

17. The non-transitory computer readable storage medium of claim 15, wherein the request comprises a backup schedule comprising at least one time to perform the data backup operation.

18. The non-transitory computer readable storage medium of claim 15, wherein identifying at least one agent application operating on a remote network device comprises identifying a first agent application and a second agent application, and wherein transmitting the at least one setup file to the remote network device comprises transmitting a backup dynamic linked library (DLL) to the first agent and transmitting a storage server DLL to the second agent application.

19. The non-transitory computer readable storage medium of claim 18, wherein the processor is further configured to perform:
performing an authentication operation between the first agent application and the second agent application; and
responsive to the authentication operation, creating at least one data backup task; and
transmitting the data backup task to a remote database which is configured to receive and store the backup data.

20. The non-transitory computer readable storage medium of claim 15, wherein the remote database is configured to perform backup data operations only responsive to the request to perform the data backup operation being received, and wherein the authentication is performed responsive to the data backup operation being performed.
